(19) United States
(12) Patent Application Publication
(10) Pub. No.: US 2007/0189353 A1
(43) Pub. Date: Aug. 16, 2007

(54) Waveguide laser having reduced cross-sectional size and/or reduced optical axis distortion

(75) Inventor: Nathan P. Monty, Charlton, MA (US)

Correspondence Address: NIXON & VANDERHYE, PC, 901 NORTH GLEBE ROAD, 11TH FLOOR, ARLINGTON, VA, 22203, US

(73) Assignee: VIDEOJET TECHNOLOGIES, Washington, DC (US)

(21) Appl. No.: 11/700,955

(22) Filed: Feb. 1, 2007

Related U.S. Application Data
(60) Provisional application No. 60/764,774, filed on Feb. 3, 2006.

(51) Int. Cl. H01S 3/22; H01S 3/097

(52) U.S. Cl. 372/87; 372/55

(57) ABSTRACT

Certain example embodiments of this invention relate to waveguide lasers (e.g., RF-excited waveguide lasers). Certain example embodiments of this invention provide combined waveguide cover and non-coupled top electrodes, and/or heat load balancing vacuum vessels including multiple (e.g., two or more) chambers. In certain example embodiments, RF energy may couple through the combined waveguide cover and non-coupled top electrode without significantly traversing the insulating carrier material via one or more cutouts or gaps formed in the RF coupling region of the top (or even a bottom) electrode. In certain example embodiments, first and second chambers of the vacuum vessel may be arranged so that heat generated in the discharge region flows away from the first and second chambers, thereby reducing thermally induced distortion of the optical component during laser operation. These techniques may be used alone or in various combinations.

### CROSS-REFERENCE TO RELATED APPLICATION

This application claims the benefit of U.S. provisional patent application No. 60/764,774, filed on Feb. 3, 2006, the entire contents of which are hereby incorporated herein by reference.

### FIELD OF THE INVENTION

Certain example embodiments of this invention relate to waveguide lasers including but not limited to RF-excited waveguide lasers. More particularly, certain example embodiments of this invention relate to techniques for reducing the cross-sectional size and/or optical axis distortion of waveguide lasers by, for example, providing combined waveguide cover and non-coupled top electrodes and/or heat load balancing vacuum vessels including two chambers.

### BACKGROUND AND SUMMARY OF EXAMPLE EMBODIMENTS OF THE INVENTION

A waveguide laser often includes mirrors, concave or flat, defining an optical resonator cavity coupled together with a waveguide defining an optical path between the mirrors.

The waveguide typically includes a channel ground into a ceramic block (e.g. aluminum oxide, Al₂O₃) with a lower electrode of aluminum or copper added to complete a cross-section of the waveguide. Alternatively, the waveguide can be ultrasonically drilled down through a piece of ceramic such as aluminum oxide (Al₂O₃) to create a continuous closed bore length with upper and lower electrodes parallel to the bore length. Typically, the positive arm of the oscillating electromagnetic field (e.g. Radio Frequency or RF) supply is coupled into the upper electrode of the waveguide, and the ground plane of the RF supply is coupled to the lower electrode. Resonance is added between and along the length of the upper electrode to distribute the RF voltage evenly along the length of the electrodes. Finally, the mirrors and waveguide structure are aligned and housed in a vacuum vessel (laser housing) that holds the gas to be excited.

Unfortunately, conventional waveguide lasers suffer from several disadvantages. For example, CO₂ lasers traditionally suffer from both a relatively large cross-sectional size and optical axis distortion because of differential heat removal from the laser's vacuum vessel. Current mechanical systems that hold and position the CO₂ laser's waveguide and vacuum vessel tend to expand the waveguide's small cross-sectional size by up to a factor of 20, and heat removal solutions for existing waveguide lasers that extract heat primarily through one side of the laser cause differential thermal expansion of the laser vacuum vessel.

Thus, it will be appreciated by those skilled in the art that there exists a need for improved waveguide lasers (e.g., CO₂, N₂, and/or other waveguide lasers) that overcome one or more of these and/or other disadvantages.

One aspect of certain example embodiments of this invention relates to a combined waveguide cover and non-coupled top electrode. Such combined waveguide cover and non-coupled top electrode may have one or more cutouts or gaps formed therein.

Another aspect of certain example embodiments relates to techniques for improving heat load balancing for laser vacuum vessels. Such techniques may include using two adjacent chambers, with a first chamber being a discharge chamber having a lasing region and the second chamber being a gas ballast chamber for example.

In certain example embodiments of this invention, there is provided a waveguide laser comprising: an electrode comprising a substantially metallic layer deposited on an insulating carrier material, and wherein the electrode along its length is provided with substantially parallel elongated opposite sides, each of said sides including at least one gap and/or cutout in an RF coupling region of the electrode so as to allow RF energy to couple through the electrode without traversing the insulating carrier material.

In certain example embodiments, a top electrode for use with an RF discharge laser is provided. A metallic or substantially metallic layer is deposited on an insulating carrier material. The top electrode may be generally elongated with substantially parallel long sides. Each said long side may include at least one cutout and/or gap in an RF coupling region so as to allow RF energy to couple through the top electrode without traversing the insulating carrier material.

In certain example embodiments, a gas discharge laser is provided. The gas discharge laser may provide a vacuum vessel having an optical element connected to at least one of its ends. The vacuum vessel may comprise substantially adjacent first and second chambers. The first chamber may be a discharge chamber accommodating a discharge region. The second chamber may be a gas ballast chamber. The first and second chambers may be arranged so that heat generated in the discharge region flows away from the first and second chambers, thereby reducing thermally induced distortion of the optical component during laser operation.

In still other example embodiments, a gas discharge laser is provided. This gas laser may comprise a top electrode for use with an RF discharge laser. The top electrode may include a metallic or substantially metallic layer deposited on an insulating carrier material. The top electrode may be generally elongated with substantially parallel sides, and with each said side including at least one cutout or gap in an RF coupling region so as to allow RF energy to couple through the top electrode without traversing the insulating carrier material. A vacuum vessel may have an optical element connected to at least one of its ends, with the vacuum vessel comprising substantially adjacent first and second chambers. The first chamber may be a discharge chamber accommodating a discharge region. The second chamber may be a gas ballast chamber. The first and second chambers may be arranged so that heat generated in the discharge region flows away from the first and second chambers, thereby reducing thermally induced distortion of the optical component during laser operation.

The aspects and embodiments may be used separately or applied in various combinations in different embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a perspective view of a waveguide laser;

FIG. 2 is a cross-sectional view of a waveguide laser;

FIG. 3 is a longitudinal view of section IV-IV in FIG. 4 of a laser;

FIG. 4 is an end view from the output coupler end of the laser;

FIG. 5 is a combined waveguide cover and non-coupled top electrode, in accordance with an example embodiment; and,

FIG. 6 is an end-portion of a laser vacuum vessel, in accordance with an example embodiment.

### DETAILED DESCRIPTION OF EXAMPLE EMBODIMENTS OF THE INVENTION

In certain example embodiments of this invention, certain gas (e.g., CO₂, N₂, etc.) lasers may be constructed in stable, unstable, and/or waveguide resonator formats. The waveguide resonator format provides a relatively small waveguide cross-section (typically about 0.1 square inches, or other suitable dimension), and a higher discharge volume density than a stable or unstable resonator format. Existing design techniques create a large vacuum vessel around the waveguide, expanding the waveguide laser cross-section from about 0.1 square inches to typically about 2 square inches or the like. However, for certain applications (e.g., for product identification applications, such as, for example, marking food packaging and bottling, etc.), there is a need and/or desire to achieve a smaller cross-section. For example, it may be desirable in certain applications to achieve a cross-section of only about 1 square inch, or less, which translates into an almost 75% cross-sectional reduction from the typical 2 square inch cross-section. These dimensions are provided for purposes of example only and are not intended to be limiting unless expressly claimed.

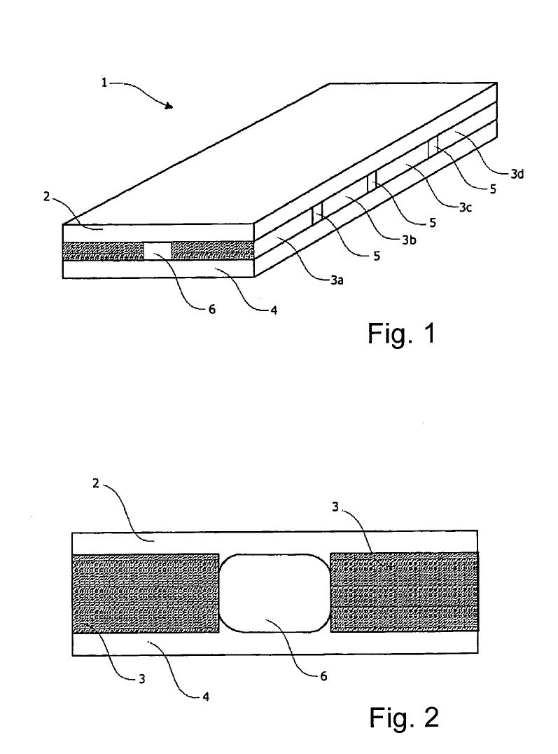

Referring now more particularly to the drawings in which like reference numerals indicate like parts throughout the several views, FIGS. 1-4 serve to illustrate the operation of certain waveguide lasers. FIG. 1 shows a slab waveguide laser 1, comprising a top or upper electrode 2 and a bottom or lower electrode 4. The upper and lower electrodes, 2 and 4 respectively, can have variable shapes (e.g., planar, variable thickness, curved, etc.). Sidewalls 3a-d are sandwiched between the upper electrode 2 and the lower electrode 4 and may be separated by small gaps 5. The width and thickness of the sidewalls are shown shaded. The length of the sidewalls are not shaded in FIGS. 1-2. The sidewalls 3a-d may be formed from any suitable material. For example, the sidewalls 3a-d may be constructed of various materials depending on the dielectric properties desired. The sidewalls may be constructed of ceramic materials (e.g., Beryllium Oxide (BeO), Aluminum Nitride (AIN), etc.).

The sidewalls 3a-d and the upper and lower electrodes 2 and 4 respectively can form a waveguide 6. There can be no gaps or any number of gaps between any number of sidewalls 3. The sidewalls may seal the waveguide 6 at a predetermined pressure. For example, the waveguide 6 can be sealed at various pressures depending, for example, upon the lasing medium or desired operating conditions. Also, the waveguide may have electrodes 2 and 4, side walls 3a-d with no gaps. In such an embodiment, the side walls 3a-d would extend and surround the electrodes 2 and 4 to form the housing of the laser itself. Likewise, the electrodes 2 and 4 could form the housing of the laser.

The sidewalls 3a-d (etc.) act to guide the beam to an extent that there is little or no appreciable beam degradation or power loss even if there are gaps between the sections of the sidewalls or sections of the sidewalls and electrodes 2 and 4. Gaps 5 can be of variable size (e.g. about 1-3 mm, or more or less) without substantially affecting the beam.

FIG. 2 is an end view through a transverse section of the waveguide laser 1 of FIG. 1. The upper electrode 2 and the lower electrode 4 are shown shaped so as to form the waveguide 6, with rounded corners (or corner protrusions). The shape of the electrodes 2 and 4 are easily changed such that easier striking and better mode control of the beam is provided. In waveguide lasers and other types of lasers, it is desirable for circular symmetry to exist in the beam in certain example instances, which will produce a Gaussian shape to the beam intensity. The electrodes may be rounded further than is shown such that there is complete circular symmetry in the waveguide (e.g., the waveguide is completely circular in cross-section) in certain instances. The variable shaping of the cross section of the electrodes can be shaped by conventional methods (e.g., by CNC Milling, etc.).

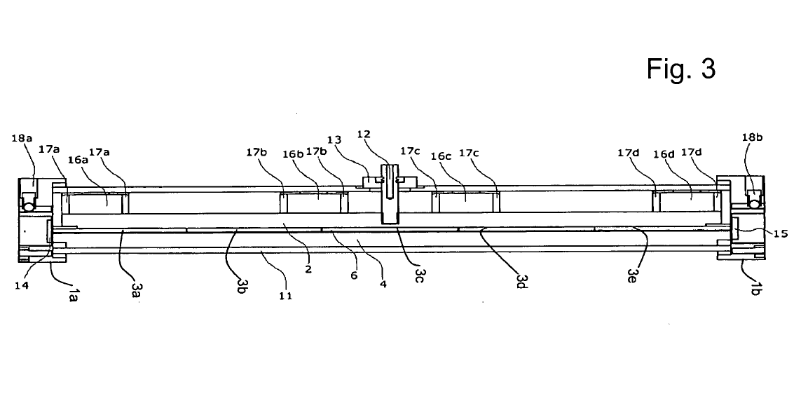

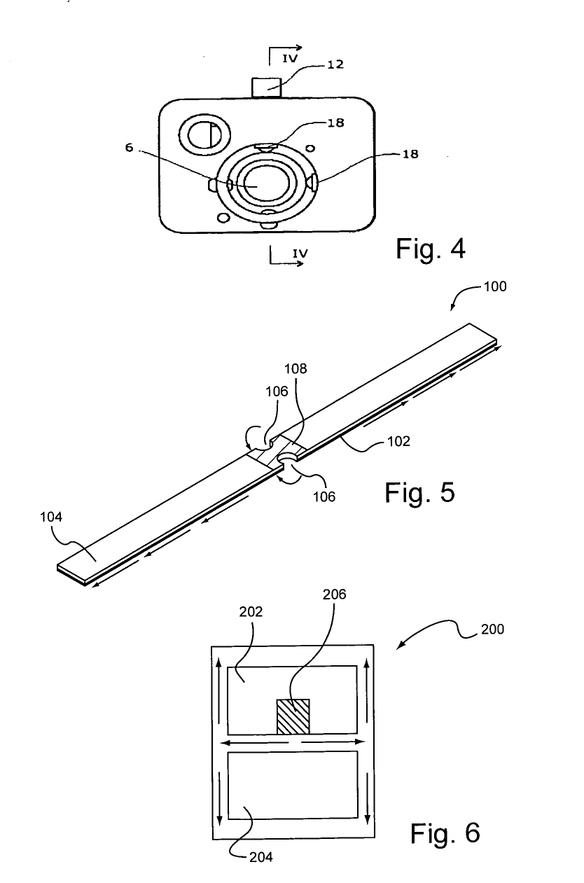

FIG. 3 shows a longitudinal view of section IV-IV of the waveguide laser in FIG. 4. The laser 1 can be disposed within a housing 11 and comprises a cavity located between the two ends 1a and 1b. End 1a comprises a reflective surface and end 1b comprises a partially reflective surface which forms the output coupler. The RF feed-through 12 can be encircled in an insulating casing 13 (e.g., an insulating ceramic casing). The insulating casing 13 can be comprised of various materials (e.g., BeO, AIN, Al₂O₃, other suitable insulating and/or dielectric material(s), etc.). Although discussion herein has referred to various components, the arrangement of such components and the presence of such components should not be interpreted as limiting the scope of the present invention. A separate housing is not necessarily needed in a sealed waveguide structure containing reflective elements, where the sidewalls or electrodes additionally form the housing.

The laser 1 can be disposed in a housing 11, with an electrode top or upper plate 2 and bottom or lower electrode plate 4. The top or upper electrode 2 is shown as continuous, but also may comprise one or more sections to assist in alleviating warping caused by, for example, temperature differentials between the topside and bottomside of the electrodes. The waveguide 6 may be disposed between a total reflector 14 and a partially reflecting surface 15. The total reflector 14 and partially reflecting surface 15 may be located at the ends of waveguide 6. The partially reflecting surface 15 may at least partially form the output coupler for the beam. The beam can make one or more passes through the waveguide before exiting at the output coupler. It will be appreciated that the number and placement of waveguides is given by way of example and without limitation. For example, certain lasers may have multiple waveguides, with the waveguides being connected or separate.

The embodiment of FIG. 3 illustrates a case where the ceramic sidewalls 3a-e abut each other, leaving no gaps. In FIG. 3, four ceramic cylinders 16a-d are used to provide a clamping force between the laser housing and the electrode assembly to hold the laser together. The cylinders 16a-d may be made of various materials (e.g., BeO, AIN or Al₂O₃, other suitable ceramic, etc.). The cylinders 16a-d are shown as being provided with inductors 17a-d, respectively, which help ensure that the voltage difference along the length of the laser is reduced. At least one power source may be connected via connector 12.

Adjustors 18a-b can be used to adjust the optics. For example, adjustors 18a-b may comprise screw adjustors, although it will be appreciated that other adjustors may be used to adjust the optics in the same planes and/or in other planes in place of, or in addition to, such screw adjustors. Adjustors 18a-b are optional, and the type of adjuster is not limited to optical or other kinds of adjusters.

FIG. 4 is an end view of a laser. Two optic adjustors 18 may be placed orthogonal to each other to facilitate the adjustment of the optics in two planes, both perpendicular to the optical axis of the beam, the optical axis lying parallel to the bore 6. It will be appreciated that other adjustment means, not shown, can be used to adjust the optics in the direction parallel to the beam.

Certain example embodiments provide techniques for reducing the laser waveguide format such that the vacuum vessel also may be reduced. Furthermore, in certain example embodiments, the reduction of the laser discharge components may be achieved without changing the laser excitation electrical circuit, thus providing high efficiency and consistent performance. Corresponding techniques are described below.

1. Combined Waveguide Cover and Non-Coupled Top Electrode Examples

FIG. 5 illustrates a combined waveguide cover and non-coupled top electrode 100, in accordance with an example embodiment of this invention. In FIG. 5, the top electrode is a very thin metallic or substantially metallic layer 102 (e.g., about 0.002″ thick, from about 0.001 to 0.05″ thick, or some other suitable thickness) added to (e.g., coated on) a very thin insulating carrier material 104 (e.g., about 0.060″ thick, from about 0.01 to 0.5″ thick, more preferably from about 0.02 to 0.10 inches thick), such that a single piece 100 (e.g., about 0.062″ thick, or other suitable thickness based on the dimensions above, in total) provides both the top cover of the waveguide discharge region and the top electrode in the discharge circuit.

Certain example embodiments of this invention are not limited to any particular type of metallic layer 102 or insulating carrier material 104. By way of example and without limitation, the metallic or substantially metallic layer 102 may comprise, for example, one or more metals and, more particularly, one or more of silver, gold, copper, and aluminum, or alloys thereof, or any other suitable metal based layer. Also by way of example and without limitation, the insulating carrier material 104 may be any suitable ceramic.

One or more cutouts 106 are provided in the insulating carrier piece 104 and/or metallic layer 102, so that the RF electrical energy does not have to be coupled through the waveguide cover (e.g., ceramic waveguide cover), therefore reducing the extra capacitance in line with the laser discharge. In particular, FIG. 5 shows two substantially semi-circular cutouts 106, with each substantially semi-circular cutout 106 being disposed on opposing sides of the longitudinal sides of assembled combined waveguide cover and non-coupled top electrode 100. The cut-outs (or recesses) 106 may be semi-circular as shown in FIG. 6, but instead may be rectangular, triangular, oval, or any other suitable shape. It is noted that “non-coupled” means that there is no direct physical contact (i.e., a non-coupled electrode can still have electrical coupling, for example such electrical coupling may occur in an electrical coupling region via one or more gaps, cutouts or the like).

As can be seen in FIG. 5, the gaps (e.g., cutouts or recesses) 106 are located in an RF coupling region 108, the RF coupling region 108 being where or proximate where the RF signal is input. Accordingly, in certain example embodiments, the RF energy will traverse the insulating carrier material 104, for example, in one or more of the directions indicated by the arrows set forth in FIG. 5.

The present invention is not limited to cutouts of any particular shape, size, location, and/or number. Moreover, the present invention is not limited to cutouts, per se. By way of example and without limitation, any sort of gap could be used for 106, with the term “gap” being broad enough to include, for example, cutouts, recesses, indentations, tabs, perforations, through-holes, and/or the like. Also, the positioning of such gaps may be symmetrical or asymmetrical, and one or more different kinds of gaps may be disposed around the combined waveguide cover and non-coupled top electrode 100.

2. Heat Load Balancing Examples

Low power lasers tend to be relatively short. For example, optical resonators of less than about 16 inches are typical. Thus, they tend to be more sensitive to thermal movement of the resonator mirrors. The heat generated by the laser discharge typically is extracted through one side of the laser vacuum vessel. In this case, the heat is said to be extracted through a “single axis.” The heat extraction axis grows at a greater rate than the opposing axis, creating differential thermal growth. Because the output optic acts as both the front resonator mirror and the front vacuum vessel sealing point, when the vacuum vessel grows differential and warps, the output optic tilts and distorts the optical outputs.

However, certain example embodiments provide a mechanical assembly arrangement that provides more equal (e.g., substantially equal) laser discharge heat removal through both sides of the laser vacuum vessel. More equal heat removal reduces the warping of the vacuum vessel relative to the resonator optical axis as it thermally expands. Therefore, as the laser heats, the vacuum vessel grows approximately along the optical axis, the output optic grows along the optical axis, and the effect on the optical mode and power is reduced in certain example embodiments. With a stable or unstable resonator, the distance between the mirrors is noteworthy, so even if the laser grows along the optical axis, the beam mode is affected. By contrast, with a waveguide laser, the resonator mirrors coupling efficiency between the mirror and the waveguide is affected, but because the waveguide and resonator mirrors are both mounted on the same vacuum vessel, the waveguide and resonator mirrors grow roughly the same amount, thus only marginally affecting the mirror-to-waveguide coupling efficiency.

FIG. 6 is an end-portion of a laser vacuum vessel 200, in accordance with an example embodiment of this invention. The laser vacuum vessel 200 is divided into two chambers 202, 204. The upper chamber 202 is the laser discharge chamber, which includes the lasing region 206. The bottom chamber 204 is a gas ballast. In certain example embodiments, the bottom chamber 204 may be optically inactive. However, in certain other example embodiments, the bottom chamber 204 also may be a discharge chamber. Chambers 202 and 204 may or may not be approximately the same size (in cross section and/or otherwise) in certain example embodiments. An optical component (not shown) may serve to seal the vacuum vessel 200, and it will be appreciated that the optical component may be an output coupler in certain illustrative configurations.

The mechanical arrangement depicted with reference to FIG. 6 allows the discharge heating to flow more equally (e.g., substantially) out both sides of the vacuum vessel and reduces (sometimes possibly even eliminating) the amount of thermal imbalance. More particularly, the heat will flow in one or more of the directions indicated by the arrows in FIG. 6.

It will be appreciated that the arrangement shown in FIG. 6 is illustrative in nature and should not be taken as limiting. For example, although the two discharge chambers 202, 204 are shown as being substantially symmetrical about a horizontal axis, the present invention is not so limited. Also, it will be appreciated that although the two discharge chambers 202, 204 are shown as “stacked,” the present invention is not so limited. By way of example and without limitation, the two discharge chambers 202, 204 may be located “next to” each other or in any other suitable substantially adjacent manner.

3. Combined Examples

Although the combined waveguide cover and non-coupled top electrode examples and the heat load balancing examples were described separately above, the present invention is not so limited. To the contrary, the example embodiments described herein may be used alone or in various combinations. For example, the combined waveguide cover and non-coupled top electrode examples and the heat load balancing examples may, or may not, be combined to realize the advantages of both arrangements in certain example instances.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A waveguide laser comprising:
an electrode comprising a substantially metallic layer deposited on an insulating carrier material, and
wherein the electrode along its length is provided with substantially parallel elongated opposite sides, each of said sides including at least one gap and/or cutout in an RF coupling region of the electrode so as to allow RF energy to couple through the electrode without traversing the insulating carrier material.

2. The waveguide laser of claim 1, wherein the gaps and/or cutouts are symmetrically disposed on the opposite sides of the electrode.

3. The waveguide laser of claim 1, wherein the gaps and/or cutouts are substantially semi-circular in shape.

4. The waveguide laser of claim 1, wherein the RF coupling region is provided substantially midway along the electrode.

5. The waveguide laser of claim 1, wherein the substantially metallic layer comprises one or more of silver, gold, copper, and aluminum.

6. The waveguide laser of claim 1, wherein the insulating carrier material comprises ceramic.

7. The waveguide laser of claim 1, wherein the substantially metallic layer is from about 0.001 to 0.05 inches thick, and/or the insulating carrier material is from about 0.01 to 0.5 inches thick.

8. The waveguide laser of claim 1, wherein the laser comprises another electrode, and a waveguide is provided between the electrodes, and wherein the laser is an RF discharge laser.

9. A gas discharge laser, comprising:
a vacuum vessel including an optical element connected to at least one of its ends, the vacuum vessel comprising substantially adjacent first and second chambers,
wherein the first chamber is a discharge chamber accommodating a discharge region, and the second chamber is at least a gas ballast chamber, and
wherein the first and second chambers are arranged so that heat generated in the discharge region flows away from the first and second chambers, thereby reducing thermally induced distortion of the optical component during operation of the laser.

10. The laser of claim 9, wherein the first and second discharge chambers are disposed substantially symmetrically about a mid-plane separating the first chamber and the second chamber.

11. The laser of claim 9, wherein the second chamber is optically inactive.

12. The laser of claim 9, wherein the second chamber also is a discharge chamber.

13. The laser of claim 9, wherein the optical component is an output coupler.

14. A gas discharge laser comprising:
a top electrode including a metallic layer deposited on an insulating carrier, and wherein the top electrode is generally elongated in shape with substantially parallel elongated sides, one or both of said elongated sides including at least one cutout and/or gap in an RF coupling region so as to allow RF energy to couple through the top electrode without significantly traversing the insulating carrier; and
a vacuum vessel comprising an optical element connected to at least one of its ends, the vacuum vessel comprising substantially adjacent first and second chambers,
wherein the first chamber is a discharge chamber accommodating a discharge region,
wherein the second chamber is at least a gas ballast chamber, and
wherein the first and second chambers are arranged so that heat generated in the discharge region flows away from the first and second chambers, thereby reducing thermally induced distortion of the optical component during laser operation.

15. The laser of claim 14, wherein the cutouts and/or gaps are symmetrically disposed on opposing sides of the top electrode.

16. The laser of claim 14, wherein the metallic layer comprises one or more of silver, gold, copper, and aluminum, and wherein the insulating carrier comprises ceramic.

17. The laser of claim 14, wherein the first and second discharge chambers are disposed substantially symmetrically about a mid-plane separating the first chamber and the second chamber.

18. The laser of claim 14, wherein the second chamber is optically inactive.

19. The laser of claim 14, wherein the second chamber also is a discharge chamber.

20. The laser of claim 14, wherein the optical component is an output coupler.
